(19) United States
(12) Patent Application Publication
(10) Pub. No.: US 2016/0376450 A1
(43) Pub. Date: Dec. 29, 2016

(54) Hydrophobicization of hard-coating surfaces

(71) Applicant: RODENSTOCK GMBH, Munich (DE)

(72) Inventors: Stefan Jung, Hohenschäftlarn (DE); Stefan Seidl, Munich (DE)

(21) Appl. No.: 15/121,494

(22) PCT Filed: Mar. 10, 2015
(86) PCT No.: PCT/EP2015/000534

§ 371 Date: Aug. 25, 2016

(30) Foreign Application Priority Data
Mar. 19, 2014 (DE) 10 2014 003 922.6

(51) Int. Cl. C09D 5/16; C09D 7/12; B05D 3/10; B05D 1/00; B05D 1/18; B05D 1/40; C09D 183/08; C09D 1/00

(52) U.S. Cl. CPC C09D 5/1681; C09D 183/08; C09D 7/1266; C09D 1/00; B05D 1/60; B05D 1/005; B05D 1/18; B05D 1/40; B05D 3/101; C08K 3/22

(57) ABSTRACT

The present invention relates to a process for hydrophobicizing hard-coating surfaces and also a hard-coated substrate having a hydrophobicized surface.

The present invention relates to a process for hydrophobicizing hard-coating surfaces and also a hard-coated substrate having a hydrophobicized surface.

Processes for hydrophobicizing glass substrates, for example ophthalmic lenses composed of glass, by means of hydrolysable silane compounds have been known for a long time. In processes of this type, a silanyl radical is covalently bound to the glass surface with formation of an Si—O—Si bond. The nonpolar silanyl radicals bound to the surface of the glass increase the hydrophobicity of the glass surface. It is a prerequisite of this process that terminal hydroxyl groups or oxygen atoms are present on the surface of the substrate which is to be hydrophobicized. In the case of silicate-based glasses, this prerequisite is met.

The situation is different in the case of substrates which are made up of materials which do not have any terminal hydroxyl groups or oxygen atoms. Such substances include, for example, those whose surface does not have any OH groups or oxygen atoms, in particular substrates whose surface is formed by a polymer coating without appropriate functions. When an attempt is made to apply a conventional hydrophobicization process to such a substrate, no increase or only a very small increase in the hydrophobicity of the substrate surface or hard-coating surface is observed. Depending on the hydrolysable silane compound, there is no suitable reaction partner available and formation of a covalent bond does not occur and the hard-coating surface remains unchanged.

EP 2 270 071 A1 describes an acrylate compound which has hydrophobic groups and can be added to a hard-coating composition in order to obtain a hard coating having increased hydrophobicity.

It is therefore an object of the present invention to provide a process for hydrophobicizing hard-coating surfaces, by means of which a hard-coating surface having a high hydrophobicity can be produced, with the hydrophobicization having a high resistance and stability, and also a hard-coated substrate having a corresponding hydrophobic surface.

This object is achieved by the embodiments set forth in the claims.

In particular, the present invention provides a process for hydrophobicizing hard-coating surfaces, where the hard coating includes a polymer matrix and nanoparticles which comprise at least one inorganic oxide and has been at least partially applied to the surface of a substrate, wherein the process comprises the following steps:
plasma etching of the hard-coating surface in order to selectively remove part of the polymer matrix and partially expose at least part of the nanoparticles, and
application of a hydrophobicizing composition which comprises a hydrolysable polyfluorinated silane compound to the plasma-etched hard coating, as a result of which polyfluorinated silanyl radicals are covalently bound to the exposed surface of the nanoparticles.

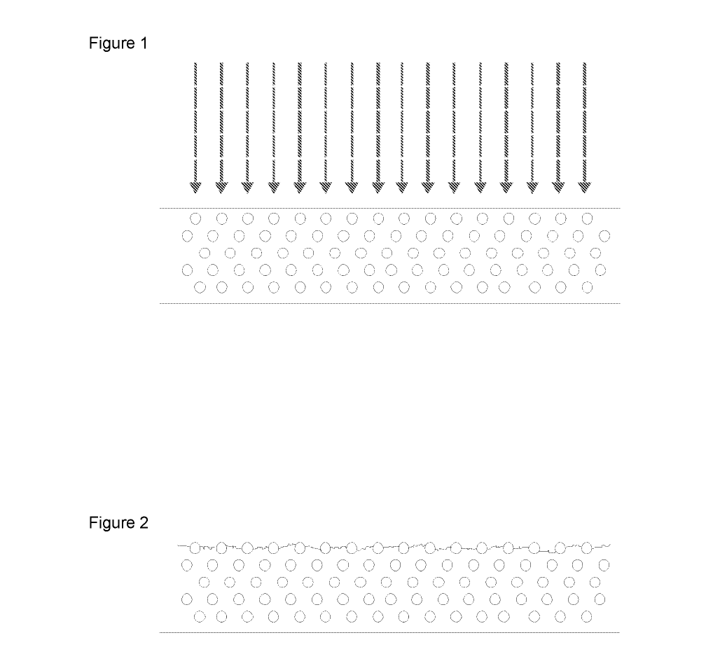

According to the invention, part of the polymer matrix is selectively removed by plasma etching of the hard-coating surface. In this context, “selectively removed” means that only or at least predominantly the polymer matrix is removed by the plasma etching but the nanoparticles present therein are not removed or at least removed to a much smaller extent than the polymer matrix. Thus, after plasma etching, some of the nanoparticles present in the hard coating project out from the surface of the polymer matrix. However, the nanoparticles which have been partially exposed in this way still remain anchored in the polymer matrix after plasma etching (see FIGS. 1 and 2).

The surface coating admixed with nanoparticles has an initial roughness after application. If this surface coating is subjected to the plasma etching according to the invention, this roughness increases since only the surface coating is etched but the nanoparticles are not. Thus, the roughness of the surface can be set individually and in a targeted manner via the plasma parameters such as time or power. The properties of the surface, e.g. reflectivity, can thus be continuously altered and brought to the desired value. The partially exposed nanoparticles produce surface structuring which has a reflection-reducing property and at the same time has a high mechanical abrasion resistance. Thus, hard-coating surfaces which at the same time have hydrophobic properties and reduced reflectivity can be provided by means of the process of the invention.

It is sufficient for the purposes of the process of the invention for at least a certain part of the nanoparticles present in the polymer matrix to be partially exposed so that at least part of the surface of the hard coating is occupied by the exposed surface of the nanoparticles. In a preferred embodiment of the present invention, the hard coating contains from 5 to 80% by weight, based on the total mass of the cured hard coating, of the nanoparticles, particularly preferably from 10 to 50% by weight, in particular from 20 to 30% by weight. Preference is given to from 10 to 90%, particularly preferably from 30 to 70%, of the partially exposed nanoparticles being exposed to an extent of from 10 to 90%, particularly preferably from 30 to 70%, based on the total surface area of the nanoparticle. Within these ranges, both a particularly large surface area of partially exposed nanoparticles is provided and also stable anchoring of the partially exposed nanoparticles in the polymer matrix is ensured.

In a preferred embodiment of the present invention, the nanoparticles have an average particle diameter of from 1 to 100 nm, preferably from 10 to 80 nm, particularly preferably from 15 to 65 nm. The average particle diameter can be determined by analysis of a scanning electron micrograph (SEM) of a sample of the nanoparticles, for example by manual measurement of the particle diameter of ten randomly chosen nanoparticles and formation of the arithmetic mean.

The nanoparticles comprise at least one inorganic oxide. The nanoparticles are preferably made up of one or more mineral metal oxides. In a preferred embodiment of the present invention, the inorganic oxide comprises at least one of Al, Si, Zn, V, Sn, Sb, Zr, Y, Ta, Ti, In, Ca, Mg and/or Ce. The nanoparticles are preferably made up of one or more oxides of Si, Ti, Zn, Va and Sb, for example of indium-tin oxide (ITO). A particularly preferred oxide of which the nanoparticles can be made up is silicon dioxide.

The shape of the nanoparticles is not subject to any restriction. The nanoparticles are typically present in approximately spherical form.

The plasma etching is, according to the invention not subject to any restriction. All standard processes known from the prior art for plasma etching can be employed. In plasma etching, a high-frequency or electrode-free microwave discharge is ignited in a vacuum reactor which is filled to a pressure of a few millibars with an etching gas so as to generate a highly reactive, etching-active plasma. Suitable etching gases are, for example, perfluorinated hydrocarbons such as tetrafluoromethane, hexafluoroethane, perfluoropropane, perfluorobutadiene and also perfluorinated (hetero)aromatics, sulphur hexafluoride, nitrogen (III) fluoride, boron trichloride, chlorine, hydrogen chloride and hydrogen bromide and also oxygen. Preference is given to using oxygen as etching gas. According to the invention, the parameters of the plasma etching step, e.g. plasma power, oxygen flow, pressure and etching time, are not subject to any particular restriction. Plasma etching is preferably carried out at a plasma power of from 300 W to 800 W. The preferred oxygen flow is from 50 sccm to 300 sccm. The pressure in the vacuum reactor is preferably from 1 Pa to 30 Pa. Preferred etching times are in the range from 1 to 15 minutes, particularly preferably from 3 to 10 minutes. If the parameters of plasma etching are selected within these preferred ranges, it can be ensured that from 10 to 90%, particularly preferably from 30 to 70%, of the partially exposed nanoparticles are exposed to an extent of from 10 to 90%, particularly preferably from 30 to 70%, based on the total surface area of the nanoparticles. As indicated above, this makes it possible to ensure that both a particularly large surface area of partially exposed nanoparticles is provided and stable anchoring of the partial exposed nanoparticles in the polymer matrix is present.

According to the invention, a hydrophobicizing composition is applied to the plasma-etched hard-coating surface after plasma etching. The hydrophobicizing composition comprises at least one hydrolysable polyfluorinated silane compound and usually also one or more organic solvents. In this context, “hydrolysable” means that the silane compound has at least one leaving group X which is bound to a silicon atom and can be replaced by terminal oxygen atoms and/or hydroxyl groups of the inorganic oxide of the nanoparticles and/or water molecules. Application of the hydrophobicizing composition to the plasma-etched hard-coating surface results in a corresponding substitution reaction by means of which the leaving group X is split off from the silane compound and a covalent bond to the terminal oxygen atom of the oxide is formed. As an alternative, a leaving group X of the silane compound can be split off, for example by means of water or an alcohol, even before formation of the covalent bond to the hard-coating surface. (Water and/or one or more alcohols can be added to the hydrophobicizing composition or else can enter the hydrophobicizing composition via atmospheric moisture). In this case, the covalent bond between silanyl radical and terminal oxygen atom of the inorganic oxide is formed by means of a water or alcohol condensation reaction. According to the invention, X can thus also be hydroxide or an alkoxide. As a result of the above-described reaction(s), polyfluorinated silanyl radicals are covalently bound to the partially exposed surface of the nanoparticles which project from the surface of the polymer matrix of the hard coating. Due to the silanyl radicals forming a covalent bond to the exposed surface of the nanoparticles, very resistant and stable hydrophobicization is produced.

The application of the silane compound can be effected in any way, for example by spraying, brushing, doctor blade coating, dipping or by a wad of absorbent cotton which has previously been impregnated with the hydrophobicizing composition being brought into contact with the plasma-etched hard-coating surface. Application can also be effected by means of spin/dip coating, printing, doctor blading or CVD/PVD processes.

Preferred leaving groups X are hydroxide, alkoxides, chloride, bromide, iodide, trifluoromethanesulfonate, tosylate, mesylate, fluorosulfonate. Owing to its satisfactory reactivity and the cheapness of corresponding silane compounds, the leaving group X is particularly preferably chloride. Preferred alkoxies are linear C₁-C₄-alkoxides, particularly preferably methoxide and ethoxide.

Suitable organic solvents which can be used in the hydrophobicizing composition are perfluorinated solvents, with preference being given to hydrofluoro ethers. If a solvent is present, the hydrophobicizing composition preferably contains from 90 to 99% by weight of one or more organic solvents. In addition, the hydrophobicizing composition should be water-free in order to prevent polymerization reactions of the fluorinated molecules.

Preference is given to at least 50% of the hydrogen atoms of each of the nonhydrolysable group(s) (radical(s) R in the formula below) of the polyfluorinated silane compound being replaced by fluorine atoms, particularly preferably at least 75%. In a preferred embodiment of the present invention, the nonhydrolysable group(s) of the silane compound is/are perfluorinated. As a result of a high degree of fluorination up to perfluorination of the nonhydrolysable group(s), a hard-coating surface having a particularly high hydrophobicity can be provided by means of the process of the invention. R is nonhydrolysable, i.e. stable to hydrolysis.

In a preferred embodiment of the present invention, the silane compound has the formula RₙSiX₍₄₋ₙ₎, where n is an integer from 1 to 3, R is a polyfluorinated polyether radical, X is a hydrolysable group and various radicals R and X, if present, are independent of one another. n is preferably 2, particularly preferably 1.

The silane compound is preferably crosslinkable. This is, for example, the case when the silane compound is polycondensable. For this purpose, n in the above formula must be not more than 2 since in this case crosslinking of the perfluorinated silanyl radicals which are covalently bound to the exposed surface of the nanoparticles is possible. This crosslinking results in formation of Si—O—Si bonds by condensation of two Si—OH groups. Hydrophobicization having an even higher resistance can be provided in this way. For example, it is possible to use trichlorosilanes or trialkoxysilanes such as trimethoxysilanes or triethoxysilanes. Other crosslinkable silanes are, for example, acryloxysilanes or glycidoxysilanes.

The polyfluorinated or perfluorinated polyether radical can have a branched or linear molecular skeleton; the polyfluorinated polyether radical is preferably linear. In addition, the polyether radical preferably has repeating units of the formula —[CₖFₗH₍₂ₖ₋₁₎O]—. Here, k is an integer from 1 to 6, preferably from 2 to 4, particularly preferably 2. Various indices k within a polyether chain are independent of one another, but k preferably has a constant value within a polyether chain. The integer l is at least 1, preferably at least k, particularly preferably at least an integer >1.5 k, in particular l=2k. The polyether radical is preferably perfluorinated.

The leaving group X has already been discussed above. A C—Si bond is preferably formed between each of the radicals R and Si. Although it is also possible for the radical R to be bound to the silicon atom of the silane compound via an O—Si bond, a radical R bound in this way is itself hydrolysis-sensitive. In such a case, the leaving group X preferably has a higher quality (i.e. a higher reactivity) than the radical R. This is the case particularly for the abovementioned preferred leaving groups X.

In a preferred embodiment of the present invention, the silane compound has a molecular weight of from 500 to 10000 g/mol, preferably from 1000 to 6000, particularly preferably from 1500 to 3000.

The above-described formation of a covalent bond between the exposed surface of the nanoparticles and the silanyl radicals and also the crosslinking reaction which optionally takes place with formation of Si—O—Si bonds can in principle occur even at low temperature, for example 10° C. or room temperature (25° C.). However, both reactions can be accelerated by heating the plasma-etched hard-coating surface to which the hydrophobicizing composition has been applied. For this reason, a heat treatment step is preferably carried out, preferably for a time of from 15 minutes to 24 hours, particularly preferably from 1 to 3 hours, at a temperature of from 40 to 120° C., preferably from 40° C. to 80° C., particularly preferably from 50 to 70° C., after application of the hydrophobicizing composition. A relative humidity of from 60 to 80% improves and accelerates this coupling since the water molecules promote bonding of the silane groups to the hydroxyl groups.

As an alternative to or in addition to heat treatment, the reaction between the nanoparticle surface and silane compound and also crosslinking of the silanyl radicals can be effected by UV irradiation.

In a preferred embodiment of the present invention, the heat treatment is followed by a washing step in which the substrate is rinsed at least once with water and/or an organic solvent such as acetone, ethanol, ethyl acetate, hexane or petroleum spirits, with a surface-active agent optionally being able to be added. Preference is given to using water, alcohols and mixtures thereof. As surface-active agent, it is possible to use, for example, Pricol®, a commercial dishwashing agent.

In a preferred embodiment of the present invention, the steps of provision of the substrate, application of a hard-coating composition to at least part of the substrate surface and curing of the hard-coating composition to form the hard coating are carried out before plasma etching. Here, the hard-coating composition comprises a polymer coating composition, with the nanoparticles being dispersed in the hard-coating composition.

According to the present invention, the substrate is not subject to any particular restriction. The substrate is preferably transparent. In this context, transparent means that the transmission of the substrate material at a path length of 1 cm is at least 80%. In a preferred embodiment, the substrate is made of glass or polymer, with polymer representing a particularly preferred substrate material. Suitable polymers encompass the polymers which can usually be used according to the prior art, in particular for ophthalmic purposes. For example, the substrate can be selected from among poly(C₁-C₁₂-alkyl)methacrylates, polyoxyalkylene methacrylates, polyalkoxyphenol methacrylates, cellulose acetate, cellulose triacetate, cellulose acetate propionate, cellulose acetate butyrate, polyvinyl acetate, polyvinyl alcohol, polyvinyl chloride, polyvinylidene chloride, polycarbonates, polyesters, polyurethanes, polyethylene terephthalate, polystyrene, poly-α-methylstyrene, polyvinyl butyral, copoly(styrene-methyl methacrylate), copoly(styrene-acrylonitrile) and polymers from among members of the group consisting of polyol(allyl-carbonate) monomers, polyfunctional acrylate, methacrylate or diethylene glycol dimethacrylate monomers, ethoxylated bisphenol A dimethacrylate monomers, diisopropenylbenzene monomers, ethylene glycol bismethacrylate monomers, poly(ethylene glycol) bismethacrylate monomers, ethoxylated phenol methacrylate monomers, alkoxylated polyalcohol acrylate monomers and diallylidene pentaerythritol monomers and mixtures thereof.

In particular, the substrate can be made up of a solid, transparent homopolymer or copolymer selected from the group consisting of poly(methyl methacrylate), poly(ethylene glycol bismethacrylate), poly(ethoxylated bisphenol A dimethacrylate), thermoplastic polycarbonate, polyvinyl acetate, polyvinyl butyral, polyurethane or a polymer selected from among members of the group consisting of diethylene glycol bis(allyl carbonate) monomers, diethylene glycol dimethacrylate monomers, ethoxylated phenol methacrylate monomers, ethoxylated diisopropenylbenzene monomers and ethoxylated trimethylolpropane triacrylate monomers.

In a further preferred embodiment of the present invention, the substrate is an ophthalmic polymer, for example an ophthalmic lens composed of a polymer which is preferably selected from among one of the above-mentioned polymers and mixtures thereof.

Although the hard-coating composition can be applied to only part of the substrate surface, the hard-coating composition is preferably applied over the entire surface of the substrate. Accordingly, the hard-coated substrate is preferably completely covered with the hard coating before plasma etching.

The hard-coating composition can be applied in any way to the uncoated substrate. Suitable processes for hard coating are known to those skilled in the art and encompass, for example, spin/dip coating, printing, doctor blading and CVD/PVD processes.

The nanoparticles are uniformly distributed both in the hard-coating composition and in the cured hard coating. For this purpose, the nanoparticles are dispersed without agglomeration in the hard-coating composition by means of conventional dispersing methods.

In a preferred embodiment of the present invention, the polymer matrix is made up of at least one polymer selected from among poly(meth)acrylates, polyurethanes, polyurethane acrylates, polysiloxanes (Sol-Gel systems/coatings), surface coatings based on epoxide and derivatives thereof. Apart from the nanoparticles uniformly distributed therein, the hard-coating composition therefore comprises a polymer surface coating composition which comprises an appropriate monomer (mixture) so that the hard coating is formed during curing of the hard-coating composition by polymerization of this monomer (mixtures). The hard-coating composition/the polymer surface coating composition optionally also comprises one or more organic solvents.

The curing of the hard-coating composition is not subject to any particular restrictions and can be carried out both under normal conditions and with heating to a temperature above 25° C. and/or by UV radiation. Suitable conditions for curing of the hard-coating composition are known to those skilled in the art.

In a further aspect, the present invention provides a hard-coated substrate having a hydrophobicized surface, which comprises a substrate whose surface is at least partly covered with a hard coating, wherein the hard coating includes a polymer matrix and nanoparticles which comprise at least one metal oxide, at least part of the nanoparticles is partially exposed at the hard-coating surface and polyfluorinated silanyl radicals are covalently bound to the exposed surface of the nanoparticles. The covalently bound silanyl radicals are preferably crosslinked, as a result of which particularly high resistance of the hydrophobicization is ensured.

In a preferred embodiment, the hydrophobicized hard-coated surface of the substrate according to the invention has a contact angle against water of at least >80°, preferably >90°, particularly preferably >100°. The contact angle against hexane is preferably at least >50°, particularly preferably at least >60°. The contact angle against hexane or water can be measured by means of “sessile drop drop-shape analysis” (DSA).

Such a hydrophobicized hard-coated substrate can be provided by the process of the invention as described above.

The present invention is illustrated with the aid of the following, nonlimiting example.

### EXAMPLE

An ophthalmic polymer article composed of poly(diethylene glycol bisallyl carbonate) (refractive index n=1.5) having an about 2-3 μm thick Duralux® hard coating which covered the entire surface of the substrate was used as substrate. The article was firstly plasma-etched in an oxygen atmosphere in an Actiplas® vacuum chamber for a time of 5 minutes at a plasma power of 500 watt.

The hydrophobicizing composition was then applied by rubbing a wad of absorbent cotton impregnated therewith on the plasma-etched surface of the substrate.

The hydrophobicizing composition was based on the product Mirage Premium AR Super Hydrophobic Solution from Satisloh. The solvent was HFE, procured from 3M. The molecular weight of the silane compound was about 2000 g/mol.

The plasma-etched substrate to which the hydrophobicizing composition had been applied was then heat treated at 60° C. for a time of two hours in a drying oven.

After heat treatment was complete, the glass was washed a number of times with ethanol or a mixture of ethanol/water/Pricol®.

As comparative example, the same process was carried out using a further ophthalmic glass of the same type, with in this case the plasma etching being omitted.

To test the hydrophobicization, a meandering line was drawn on each of the surfaces of the glass of the example and the glass of the comparative example by means of a felt pen (Edding 8300 Industry Permanent Marker Special). The surface of the glass of the example according to the invention was not wetted by the ink of the felt pen because of its increased hydrophobicity. A pattern of ink droplets arranged in the manner of a string of pearls was formed. This effect did not occur on the surface of the glass of the comparative example. Here, the ink wetted the surface so that a broad line could be seen.

The increased hydrophobicity of the glass of the example was also confirmed by contact angle measurements according to “sessile drop drop-shape analysis” (DSA). The corresponding results are summarized in the following table.

TABLE 1
Contact angle measurement

| | Water | Hexadecane |
|---|---|---|
| Duralux ® 1.5 untreated | 73° | 26° |
| Duralux ® 1.5 according to the invention | 102° | 64° |

Hard-coated substrates which at the same time have a hydrophobic surface and a low reflectivity can be provided particularly efficiently and economically by means of the process of the invention. The hydrophobicization of the hard-coated substrates according to the invention has a high resistance and can be produced efficiently and economically on the basis of inexpensive starting materials. After reflection-reducing properties have also been produced by the hydrophobicization process of the invention, additional antireflection coating of the substrate can be dispensed with.

1. A process for hydrophobicizing hard-coating surfaces, where the hard coating includes a polymer matrix and nanoparticles which comprise at least one inorganic oxide and has been at least partially applied to the surface of a substrate, wherein the process comprises the following steps:
plasma etching of the hard-coating surface in order to selectively remove part of the polymer matrix and partially expose at least part of the nanoparticles, and
application of a hydrophobicizing composition which comprises a hydrolysable polyfluorinated silane compound to the plasma-etched hard coating, as a result of which polyfluorinated silanyl radicals are covalently bound to the exposed surface of the nanoparticles.

2. The process as claimed in claim 1, wherein the steps
provision of the substrate,
application of a hard-coating composition to at least part of the substrate surface and
curing of the hard-coating composition to form the hard coating
are carried out before plasma etching and
the hard-coating composition comprises a polymer surface coating and the nanoparticles are dispersed in the hard-coating composition.

3. The process as claimed in claim 1, wherein the substrate consists of glass or polymer.

4. The process as claimed in claim 1, wherein the substrate is an ophthalmic polymer article.

5. The process as claimed in claim 1, wherein the inorganic oxide comprises at least one of Al, Si, Zn, V, Sn, Sb, Zr, Y, Ta, Ti, In, Ca, Mg and/or Ce.

6. The process as claimed in claim 1, wherein the nanoparticles have an average particle diameter of from 1 to 100 nm.

7. The process as claimed in claim 1, wherein the polymer matrix is made up of at least one polymer selected from among poly(meth)acrylates, polyurethanes, polyurethane acrylates, polysiloxanes, surface coatings based on epoxide and derivatives thereof.

8. The process as claimed in claim 1, wherein the nanoparticles make up from 5 to 80% by weight of the hard-coating composition.

9. The process as claimed in claim 1, wherein the silane compound has the formula RₙSiX₍₄₋ₙ₎,
where n is an integer from 1 to 3, R is a polyfluorinated polyether radical, X is a hydrolysable group and various radicals R and X are, if present, independent of one another.

10. The process as claimed in claim 1, wherein the silane compound has a molecular weight of from 500 to 10000 g/mol.

11. A hard-coated substrate having a hydrophobicized surface, which comprises
a substrate whose surface is at least partly covered by a hard coating, wherein the hard coating includes a polymer matrix and nanoparticles which comprise at least one metal oxide,
at least part of the nanoparticles is partially exposed at the hard-coating surface and polyfluorinated silanyl radicals are covalently bound to the exposed surface of the nanoparticles.
